(19) United States
(12) Patent Application Publication
(10) Pub. No.: US 2021/0329850 A1
(43) Pub. Date: Oct. 28, 2021

(54) ADAPTIVE PHOTOSYNTHETICALLY ACTIVE RADIATION (PAR) SENSOR WITH DAYLIGHT INTEGRAL (DLI) CONTROL SYSTEM INCORPORATING LUMEN MAINTENANCE

(71) Applicant: AGrow-Ray Technologies, Inc., Boulder, CO (US)

(72) Inventors: Hugh Patrick Adamson, Hubbardston, MA (US); Ivan Theodore Kruglak, Boulder, CO (US)

(21) Appl. No.: 17/321,624

(22) Filed: May 17, 2021

Related U.S. Application Data
(63) Continuation-in-part of application No. 16/384,573, filed on Apr. 15, 2019, now abandoned.
(60) Provisional application No. 62/660,002, filed on Apr. 19, 2018.
(60) Provisional application No. 62/660,039, filed on Apr. 19, 2018.

(51) Int. Cl. A01G 7/04; H05B 45/10; A01G 9/24; H05B 47/11; H05B 45/345; H05B 45/50

(52) U.S. Cl. CPC A01G 7/045; H05B 45/10; H05B 45/50; H05B 47/11; H05B 45/345; A01G 9/249

(57) ABSTRACT

An artificial grow environment system includes a luminaire, a constant current LED driver, a first light sensor, a hemispherical incident and translucent light housing, a second light sensor isolated from all light and a circuit configured to supply 0 to 10 VDC to the dimming input of the constant current LED driver such that the LED light is linearly dimmed, from full-on to full-off, in inverse proportion to an amount of ambient light received by the first light sensor as temperature-compensated in accordance with data collected by the second light sensor. The luminaire includes a light shield housing at least one LED light. The first light sensor, surrounded by a hemispherical incident, translucent light housing, is coupled to the light shield and separated from the LED light so as to be isolated from the LED light and receive ambient light in the artificial grow environment.

### CROSS REFERENCE TO RELATED APPLICATIONS

This application is a continuation-in-part of U.S. Non-Provisional application Ser. No. 16/384,573 filed 15 Apr. 2019, pending, which claims the priority benefit of U.S. Provisional Application Ser. No. 62/660,002 filed 19 Apr. 2018 and U.S. Provisional Application No. 62/660,039 also filed 19 Apr. 2018 each hereby incorporated by reference in its entirety.

### BACKGROUND

Traditional greenhouses are used to grow foods, flowers and other crops by providing a benign growing environment through control of light, temperature, humidity and other factors. This is done to optimize the growing environment, minimize the amount of water and nutrients used as well as to extend the growing season.

A key factor is the amount of available daylight. Seasonal variations limit the practicality of greenhouse use unless other factors are introduced such as heating and supplemental lighting. Both require external energy sources: Electricity for the lights, and a variety of possible sources for heat When insufficient natural sunlight is available, supplemental, electric powered lights must be used. Light Emitting Diodes (LEDs), fulfil these needs and more. However, even LEDs degrade over time. Their color temperatures and wavelengths will change, and most importantly, the light output will diminish and the color spectrum will drift.

### SUMMARY

The disclosure describes an artificial grow environment system. The system includes a luminaire, a constant current LED driver, a first light sensor, a hemispherical incident and translucent light housing, a second light sensor and a circuit configured to supply 0 to 10 VDC to the dimming input of the constant current LED driver such that the LED light is linearly dimmed, from full-on to full-off, in inverse proportion to an amount of ambient light received by the first light sensor as temperature-compensated in accordance with data collected by the second light sensor. The luminaire is configured for illuminating an artificial grow environment below the luminaire. The luminaire includes a light shield housing at least one LED light. The constant current LED driver is operatively coupled with the LED light and includes a dimming input. The first light sensor is coupled to the light shield and separated from the LED light thereby so as to be isolated from the LED light and receive ambient light in the artificial grow environment. The hemispherical incident, translucent light housing surrounds the first light sensor and is configured to accept light from above or from the sides in the artificial grow environment. The second light sensor is isolated from all light.

The disclosure also describes a method for monitoring and controlling an artificial grow environment. The method includes providing a luminaire configured for illuminating an artificial grow environment and including a light shield housing at least one LED light and providing a constant current LED driver operatively coupled with the LED light and including a dimming input. With a first light sensor coupled to the light shield and separated from the LED light thereby so as to be isolated from the LED light, ambient light in the artificial grow environment is received through a hemispherical incident, translucent light housing configured to accept light from above and from the sides. With a circuit configured to supply 0 to 10 VDC to the dimming input of the constant current LED driver, the at least one LED light is linearly dimmed, from full-on to full-off in inverse proportion to an amount of ambient light received by the first light sensor as temperature-compensated in accordance with data collected by a second light sensor that is isolated from all light.

### BRIEF DESCRIPTION OF THE FIGURES

The summary above, as well as the following detailed description of illustrative embodiments, is better understood when read in conjunction with the appended drawings. For the purpose of illustrating the disclosure, example constructions are shown in the drawings. However, the disclosure is not limited to specific methods and instrumentalities disclosed herein. Moreover, those having ordinary skill in the art will understand that the drawings are not to scale. Wherever possible, like elements have been indicated by identical numbers.

Embodiments of the disclosure will now be described, by way of example only, with reference to the following diagrams wherein:

FIG. 1 is a block diagram of an example Adaptive Photosynthetically Active Radiation (PAR) Sensor and Controller.

FIG. 2 is a circuit diagram of an example printed circuit board which may implement an adaptive PAR sensor and controller.

FIG. 3 is a high-level illustration of output by an example printed circuit board.

FIG. 4 is a block diagram of a circuit which may implement an example automatic system for lumen maintenance and compensation.

FIG. 5 is a block diagram illustrating operations of an adaptive PAR sensor and controller.

FIG. 6 illustrates a perspective view of an example adaptive PAR sensor and controller.

FIG. 7 illustrates a front view of the example adaptive PAR sensor and controller of FIG. 6.

FIG. 8 illustrates a side view of the example adaptive PAR sensor and controller of FIGS. 6 & 7.

FIG. 9 illustrates a bottom view of an example printed circuit board assembly suitable for uses in association with disclosed adaptive PAR sensor and controllers.

FIG. 10 illustrates a top view of the example printed circuit board assembly of FIG. 9.

FIG. 11 illustrates a side view of the example printed circuit board assembly of FIGS. 9 & 10.

FIG. 12 illustrates a perspective view of an example implementation of disclosed adaptive PAR sensor and controller systems in association with a luminaire fixture.

FIG. 13 illustrates a front view of the example implementation of FIG. 12.

FIG. 14 illustrates a side view of the example implementation of FIGS. 12 & 13.

### DETAILED DESCRIPTION

The following detailed description illustrates embodiments of the disclosure and manners by which they can be implemented. Although the best mode of carrying out disclosed systems and methods has been described, those of ordinary skill in the art would recognize that other embodiments for carrying out or practicing disclosed systems and methods are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

An Adaptive Photosynthetically Active Radiation (PAR) Sensor and Controller is disclosed as it may be implemented to govern the amount of supplemental lighting to make it as economical as possible to grow greenhouse crops.

The amount of supplemental lighting needed may depend at least to some extent on the latitude of the greenhouse, with far northern or far southern locations requiring progressively more supplemental lighting than near-equatorial locations.

The importance of having the correct light intensity and duration cannot be overstated. For instance, crop production may be reduced by the lack of light and plants may either take a longer period to achieve the expected biomass production, or at harvest, the plants may be undersized or not fully developed. This can be a serious problem for flower producers who have hard deadlines such as Valentine's Day, Mother's Day, or Christmas. Likewise, growers with firm delivery contracts for produce and other crops may have contractual fines if the crops are not ready on time. However, if the amount of artificial light is above the required intensity and duration, growers are wasting energy by providing light that cannot be used by the crop.

The cost of electricity is a key metric to the practicality and profitability of using supplemental lighting to hasten plant growth, and to provide the grower with additional, profitable crop cycles, healthier, more robust and larger plants which are worth more; provide the means to grow crops in the absence of sufficient sunlight. A corollary to the cost of electricity is that the method for producing light must be as efficient as possible, and produce a light spectrum and intensity that is optimal for growing plants of all sorts.

The cost of the electricity must be inexpensive enough and the luminaire efficient enough to provide the grower with a reasonable profit margin. This means that the amount of electricity must be tightly controlled to produce the best possible crop for the lowest possible electricity cost.

The most common source of supplemental light for greenhouse use is based on the old technology of arc lamps, used for street lighting from the 1870s and known today as High-Pressure Sodium (HPS) lights. The spectrum is not ideal for plant growth, the light bulb output starts to drop fairly quickly and should be replaced after approximately 6 months of use. They also contain Mercury, a toxic, heavy metal.

These lights are now being replaced by more efficient, LED (light Emitting Diode) lights, with spectra and intensity tailored for efficient plant growth. Typical life is 50,000 hours (about 11 years, 12 hours per day) to 70% of the original output.

Unlike HPS lighting, LED lights have additional advantages such as being easily dimmable over a wide range. A typical LED driver may be dimmed from 100% output to less than 10%.

The devices, systems, and their methods herein may be employed not only for the improvement of plant crop growth, but as well for the propagation and cultivation of horticultural products. The sensor system described herein provides a supplemental interactive lighting system for enhancing plant and/or crop growth. The supplemental lighting system may also include one or more gateways, servers, wireless or wired nodes, microprocessors, and networks. Such a network may be connected to cloud-based storage. The system may additionally include memory devices, a controller, such as a lighting control system, a smart condition monitor to check environmental conditions, electricity (voltage, current, power, various thresholds), plant physiology sensors, a wired/wireless communications system, and/or a light element control module such as physically and/or electrically coupled to a light fixture.

Before continuing, it is noted that as used herein, the terms “includes” and “including” mean, but is not limited to, “includes” or “including” and “includes at least” or “including at least.” The term “based on” means “based on” and “based at least in part on.” In addition, the following terms are also defined as used herein.

The term photosynthetically active radiation (PAR) is used herein to designate the spectral range (wave band) of solar radiation from 400 to 700 nanometers that photosynthetic organisms are able to use in the process of photosynthesis.

The term daily light integral (DLI) is used herein to refer to a function of photosynthetic light intensity and duration (day) and is usually expressed as moles of light (mol) per square meter (m²) per day (d⁻¹), or: mol. In other words, DLI describes the sum of the per second PPFD measurements during a 24-hour period. As indicated above, the daily light integral (DLI) is the amount of photosynthetic active radiation (PAR) received each day as a function of light intensity (instantaneous light: μmol·m²/s) and duration (day). It is expressed as moles of light (mol) per square meter (m²) per day (d⁻¹), or: mol·m²/d (moles per day). The DLI concept is like a rain gauge. Just as a rain gauge collects the total rain in a particular location over a period of time, so DLI measures the total amount of light (PAR) received in a day.

Greenhouse growers can use specialized light meters to measure the number of light photons that accumulate in a square meter over a 24-hour period to obtain readings in moles.

DLI is an important variable to measure in every greenhouse because it influences plant growth, development, yield, and quality. For example, DLI can influence the root and shoot growth of seedlings and cuttings, finish plant quality (characteristics such as branching, flower number and stem thickness), and timing. Commercial growers who routinely monitor and record the DLI received by their crops can easily determine when they need supplemental lighting or retractable shade curtains.

It is noted that luminaires using Light Emitting Diodes (LEDs) of different wavelengths, including but not limited to white light, provide an efficient and optimized plant growth spectrum and intensity. Although LEDs are referred to herein as the most current technology for supplying light to plants, nothing herein limits the technology described to LEDs. Other means to produce light may be in existence, or may be developed in the future that may also be implemented. The technology described applies equally to other means of generating light

It is noted that the examples shown and described are provided for purposes of illustration and are not intended to be limiting. Other devices and/or device configurations may be utilized to carry out the operations described herein. The operations shown and described herein are provided to illustrate example implementations. It is noted that the operations are not limited to the ordering shown. Still other operations may also be implemented.

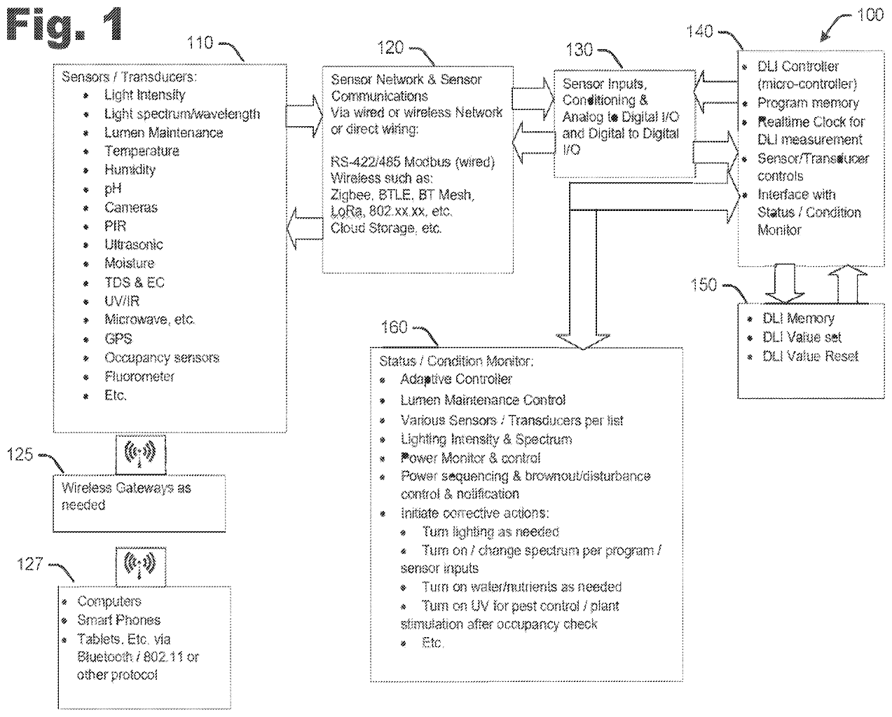

FIG. 1 is a block diagram of an example Adaptive Photosynthetically Active Radiation (PAR) Sensor and Controller. The example system 100 in FIG. 1 includes any number and/or types of sensors and/or transducers 110 to implement the operations described herein. In an example, the sensors and/or transducers 110 may be interconnected via a sensor communications network 120 and conversion 130 to provide input to a light controller 140. Suitable wired and/or wireless gateways 125 for implementing via computer device(s) 127 such as but not limited to, smart phones, tablets, etc. The light controller 140 may include computer-readable storage 150 and may implement various controls/controllers 160.

In an example, the system includes a light sensor and circuitry to linearly respond to ambient light. In the fashion of a camera light meter, it measures the light failing on its sensor from all reasonable angles. This is called an incident light sensor.

The sensor is calibrated so that when sunlight reaches a certain light (PAR) level, the LED light linearly dims to off. This PAR level is factory or field calibrated to respond to the optimum light level for the crop in question. As an example, the PAR setting might be 200 μMols for lettuce, a low light level plant, and 500 μMols for tomatoes, which require more light. The location of this sensor is important. Because the Sun is approximately 93 million miles distant, the actual location above the light fixtures is unimportant as long as the sensor is not occluded by the greenhouse or other structures or objects.

An example system includes a hemispherical incident, translucent light housing that accepts light from above or from the sides. The example system also includes a linear light sensor (e.g., a solar cell, or any other light sensitive device such as a photodiode or phototransistor to which a linearizing circuit has been added), and an identical sensor that is “blind” (isolated from all light) that functions as temperature compensation device for the active photosensitive cell. The output of this circuit supplies 0 to 10 VDC to the dimming input of a constant current LED driver to linearly dim the LED light. The intensity of the light, from full on to full off is the direct inverse of the amount of sunlight received by the calibrated photosensor. That is, more sunlight may cause more dimming of the LED lights until at a predetermined threshold, the light shuts completely off.

During operation, if a cloud passes overhead, the ambient light might drop by, for example, 30%. If there had been sufficient sunlight to keep the controlled lights off, they might turn on if the light levels at the sensor dropped below the calibrated PAR level. However, the sensor might measure sufficient residual light to respond by turning on the LED light it controls, to only 20% of its maximum output, so that the sum of the sunlight plus the artificial light adds to 100% of the light required by the plant to achieve the quickest and healthiest growth. A cloudy or rainy day might produce lower PAR levels at the sensor and the system would respond by turning on the lights anywhere up to a full, 100%.

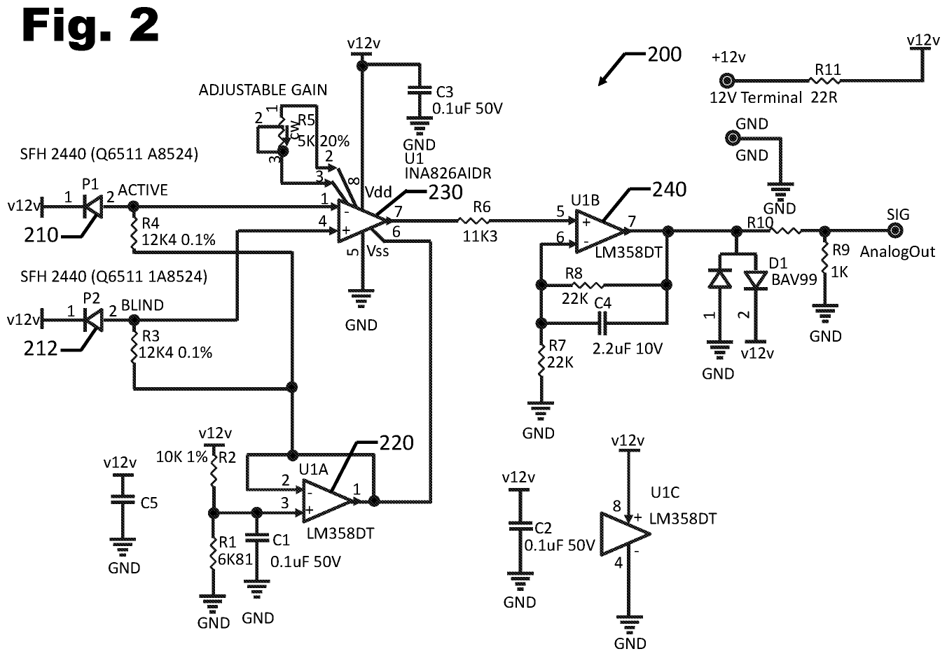

FIG. 2 is a circuit diagram 200 of an example Adaptive Photosynthetically Active Radiation (PAR) Sensor and Controller. In an example, the circuit 200 includes two photo sensors P1 210 and P2 212 biased with U1A 220 output voltage (4.85V). Both P1 210 and P2 212 are inputs for the differential amplifier U2 230.

The blind sensor (P2) 212 is covered with INDIA INK, or other means of 100% light blocking, such as opaque adhesive tape, and acts as a temperature compensation because it is biased at the same place as the active sensor P1 210 and has the same bias current. As the temperature changes, and if P1 210 saw no light, it forces the differential amplifier to the voltage created by U1A 220 (about 4.85V). But, because P1 210 is not blind, the output of U2 230 is the temperature compensated value of P1 210. U2 230 can have gain from 1 to about 50,000 allowing it to respond to very low light levels or very high light levels, depending on the gain setting. U18 240 is an amplifier with a gain of 2. For no light received by P1 210, U2 230 is biased at about 4.85 volts and there is 9.70V out of U18 240. As P1 210 receives light, the differential amplifier U2 230 goes from about 4.85 to approaching ground (0 Volts). With a gain of 2, the output voltage to the LED driver goes from about 9.70 V for no light, to about 0 for full light. Full light is created by calibrating the gain of U2 230 such that at the chosen intensity seen by P1 210, it causes the differential amplifier U2 230 to go to about 0 volts.

As the dimming control of the LED driver function is 9 to 10 V for full intensity and 0 to 1 V for LEDs off, this causes the LED driver to be at full power when there is no light at P1 210. No light at P1=4.85 volts out of U2=9.7V out of U18 240, and at full light (U2 at O volts=U18 to be OV) causes the LED driver to turn the LEDs off when the light intensity reaches full light.

In an example, the sensor is inexpensive enough so that each light in a greenhouse or similar venue, may be equipped with its own sensor. This provides the maximum flexibility to the grower as one part of the greenhouse might be shadow, where supplemental light is needed, while a different area may have sufficient sun to dim or shut off the lights in this section.

The above described sensor system is extremely effective. However, in some circumstances, another level of sophistication is desirable. In an example, the system may further include means to measure and record the Daylight Integral.

Briefly, most common plants need a certain minimum amount of light over a 24-hour period. This value has largely been determined via established research. For instance, lettuce production has been shown to require 12 to 14 mol_m−2_d−1, and tomatoes need 20 to 30 mol_m−2_d_-1. It is therefore very important that the total amount of light received by a plant be known. With this information, if insufficient light were received during a rainy or winter's day, for instance, the supplemental light can be turned on for the length of time required to make up the difference between the light received and the light required.

The system with DLI control can be implemented in a variety of ways. For example, the system may include a microcontroller measurement system featuring an analog to digital input to measure the output of the photosensor to keep track of the light levels over a given time, The microprocessor may also include a precision real time clock system to keep accurate time of day. This clock may be synchronized to the sensor output levels to measure the amount of time that sufficient light and duration were received.

Greenhouses, or similar venues may wish to grow different crops at different times. As noted above, different crops require different amounts of light. The system may be reset to provide the correct DLI for the crop to be grown. The LED Light dimming to completely off threshold may be changed either locally or remotely to the correct PAR threshold setting.

The system with DLI control as described, can either be freestanding (one per light), or part of a network. A network can be constructed using a variety of technologies, not limited to the following: a wireless network using one or more protocols such as WiFi (802.11.xx, Zigbee (802.15.4) Bluetooth (802.15.1), or wired protocols such as Modbus over RS-485, RS-422, or a combination. A network approach may be especially valuable in large installations to keep track of hundreds or even thousands of controller-equipped lights.

Many electric power companies charge different amounts per kilowatthour (kWh) depending on time of day. To economize on the electricity cost, growers may wish to have their lights come on during the period of cheapest rates, typically late at night to early morning, to avoid peak power rates. An additional level of sophistication can be incorporated in the system with DLI control and real-time clock, or off-loaded to a desktop, laptop or other computer. Equally, a smartphone application or other means may be utilized for scheduling the on/off times for these lights. Additionally, staggered turn on/off times may be programmed to avoid massive turn on power surges and turn off transients. These features may also be triggered by power failure, brown-outs, over-voltage conditions, and the like.

Another implementation of the system, may accept inputs from wireless or wired sensors such as, but not limited to temperature, humidity, CO2, and pH. The various sensor readings may be input to the system for further transmission via wired or wireless means to a computer, smartphone or other data gathering, control and display device or devices via a network or other means.

Advanced sensing devices may be used, such as a fluorometer, configured for measuring a chlorophyll fluorescence emission of a plant. These emissions may be employed so as to determine one or more characteristics of a photosynthesis process. For instance, in various embodiments, the electron transport rate may be determined by the measuring of chlorophyll fluorescence emission for the purpose of optimizing the growth process, including, but not limited to speed of growth, health of plant, and nutritive value.

Another implementation of the system, may accept a wireless or wired input to cause the LED light to alter the light spectrum created by the LEDs. Alternately, the system may implement its onboard Real Time Clock to initiate spectrum changes as described below. To actually change colors, the system may drive a multi-channel LED driver, or multiple individual drivers (one channel per light color. White is considered as a color for this purpose).

By way of illustration, Spectrum A is implemented with seedlings, clones or other delicate plants. It has been shown that many young plants benefit from a Blue-weighted spectrum, so let us call Spectrum A, Blue weighted. As the plants mature and begin to flower, a different spectrum is more effective to promote growth, flowering and beneficial characteristics such as, but not limited to, color, taste, smell and potency. Spectrum B, in many instances is red weighted, so the system may switch to Spectrum B, and to Spectrum C, D and so on, as needed. Since this implementation includes a precision real time clock, it can be programmed to switch spectra, or other functions, after a certain period of time. Alternately, the system may accept a wireless or wired input to effect these spectrum changes remotely, either from appropriate sensors or via timing or human/machine control.

Another implementation of the system can include means to measure plant height, leaf distance or other physical measurements via ultrasonic transducers, photosensors or other means. This function can alert the grower when a particular plant is ready for harvest or signal a motor that the light may be raised to prevent plant contact with the light, and/or to maintain an optimum height above the plant for ideal light dispersion and intensity.

Another implementation of the system can include means via wavelength selectable sensors, moisture sensors, or other means, to detect insect or other pests, fungal presence, lack of sufficient water, nutrients or other unhealthy conditions. This information may then be relayed via the system which is networked via wired or wireless means to a computer, smartphone or other data gathering, control and display device or devices.

Another implementation of the system can include means upon detection of pests, fungal presence, lack of sufficient water, nutrients or other unhealthy conditions to actively counteract these unhealthy conditions by, for instance, remotely turning on local watering, nutrient supply, UV light to eradicate pests, or other means to accomplish plant health restoration. This information may then be relayed via the system which is networked via wired or wireless means to a computer, smartphone or other data gathering, control and display device or devices.

Another implementation of the system can include means such as Passive Infrared (PIR), or microwave sensors to detect motion in the local environment, due to intruders, rodents or other motion-triggered events. This information may then be relayed via the system which is networked via wired or wireless means to a computer, smartphone or other data gathering, control and display device or devices. Since each light can be equipped with these sensors, including video cameras, making precise location and movement tracking in a large facility possible. This information can be sent directly to a security company, police department, and/or a person responsible for the facility.

Another implementation of the system can include means to detect fire and smoke via appropriate sensors and transmit this information via wired or wireless means to a computer, smartphone or other data gathering, control and display device or devices via a network or other means, and/or directly to a security company, fire department, and/or a person responsible for the facility.

Another implementation of the system can be to control and electronically activate a shade mechanism, common to greenhouses, to provide shade to a plant or plants, so as to alleviate heat or light stress in plants caused by over exposure to lighting, such as during the summer months when there is an overabundance of daylight. Equally, the system can retract this shading device when the heat and peak light of the day (for instance), has passed, based on its PAR, temperature or other measurements.

Another implementation of the system can include means to detect human presence or absence, called occupancy detection. Existing PIR sensor(s) may be also be used for this. If no humans are present, UV light may be switched on safely, to eradicate pests and/or to promote flowering and other beneficial attributes.

When data is available from the electric utility company, or any other data is available from other sources, such as weather, costs associated with growing crops, such as water or nutrient costs, market prices for relevant crops, the computer, smart phone or alternate data storage and display devices associated with the system can retrieve, store and act on the received data to minimize the economic impact of this data, or notify the person supervising the greenhouse to take advantage of a particular situation.

It is noted that the examples shown and described are provided for purposes of illustration and are not intended to be limiting. Still other examples are also contemplated.

Greenhouses and other facilities may have very large spaces, typically measured in acres. There may be thousands of lights in use at larger facilities. These are commonly LED-based lights (luminaires), having TM-21 projected lifetimes of 25,000, 50,000 or even 100,000 hours, equating to 5.5, 11 and 22 years respectively, at 12 hours on per day. These luminaires may have been installed at different times, represent different brands and models, and therefore pose a very difficult maintenance task to track projected lifetimes and reduced light (L70) levels over time.

A further complication is the L70 data may not be available or reliable. It also will not represent each luminaire, only an average. The human eye is not particularly sensitive to intensity changes. Detecting early failures or unexpected reduced light output may not be timely. A 30% loss of light (L70 limit) may not seem like very much, but it would have serious financial consequences to a grower who is not getting the expected results, and not understand why. It may even create liability issues, poor working conditions and/or may have other undesirable consequences with general lighting applications.

An example automatic system for lumen maintenance and compensation is disclosed which compensates for the loss of light output of a luminaire (or other light) over the light source lifetime (e.g., LED or other lighting source), as well as an end of life indication, or intermediate status. The systems and methods described herein may be implemented for lighting at greenhouses or other agricultural venues where artificial lighting is used for growing crops, and may also have general applicability in other lighting scenarios for general illumination.

In addition, IES LM-80-2008, “Measuring Lumen Maintenance of LED Light Sources” (“LM-80”), is the industry standard that defines the method for testing LED lamps, arrays and modules to determine their lumen depreciation characteristics and report the results. The goal of LM-80 is to allow a reliable comparison of test results from different laboratories by establishing uniform test methods. IES TM-21-2011, “Projecting Long Term Lumen Maintenance of LED Light Sources” (“TM-21”) is the technical memorandum that recommends a method of using LM-80 test results to determine the rated lumen maintenance life (Lp) of LED lamps. L70 is an IESNA approved method of testing Projecting Long Term Lumen Maintenance of LED Light Sources, which establishes a method for projecting lumen maintenance (and useful lifetime) of LED light sources from available LM-80 data and INSITU data. This is based on “time to failure” or when the luminous flux reduces to 70% of its original output. Example: L70 Calculated Estimates—134,273 hrs. @25° C. Ambient and 425 mA

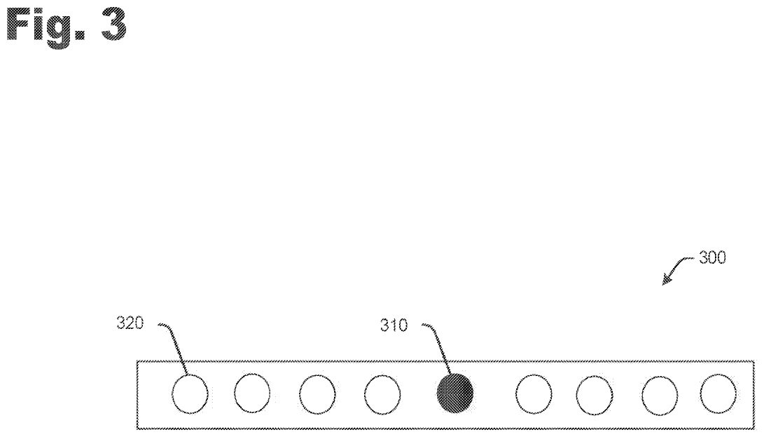

FIG. 3 is a high-level illustration of output by an example printed circuit board assembly (PCBA) 300, wherein white dots 320 represent LED or other light sources, and the black dot 310 represents a sensor. LED Luminaires are typically powered by a constant current DC source. Most have a dimming means, usually, a 0 to 10 VDC or PWM signal that produces a corresponding, linear dimming. In an example, the circuit may be implemented to regulate the light output.

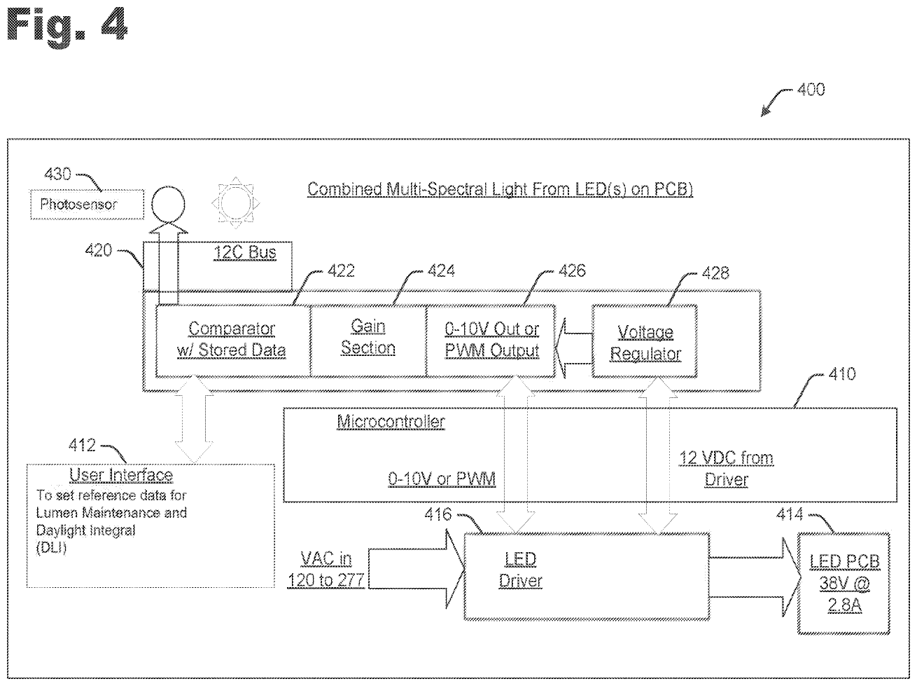

FIG. 4 is a block diagram 400 of a circuit which may implement an example automatic system for lumen maintenance and compensation. This system may be implemented as an open or closed-loop circuit, with a closed-loop circuit preferable for accuracy. In an example, the circuit may include an 8-bit microcontroller 410 based sensor solution. The microcontroller 410 may interface with a user interface 412 and LED circuit 414 via LED driver 416. An I2C bus 420 may connect to an I2C sensor 430, one that can tolerate 60,000 Lux or more. The I2C bus 420 may interface with a comparator 422, a gain section 424, PWM output 426, and a voltage regulator 428. Two spectral channels may provide a good indication of the spectral content. An example sensor is a commercially available TSL2772_DS000181_2-00-255425.

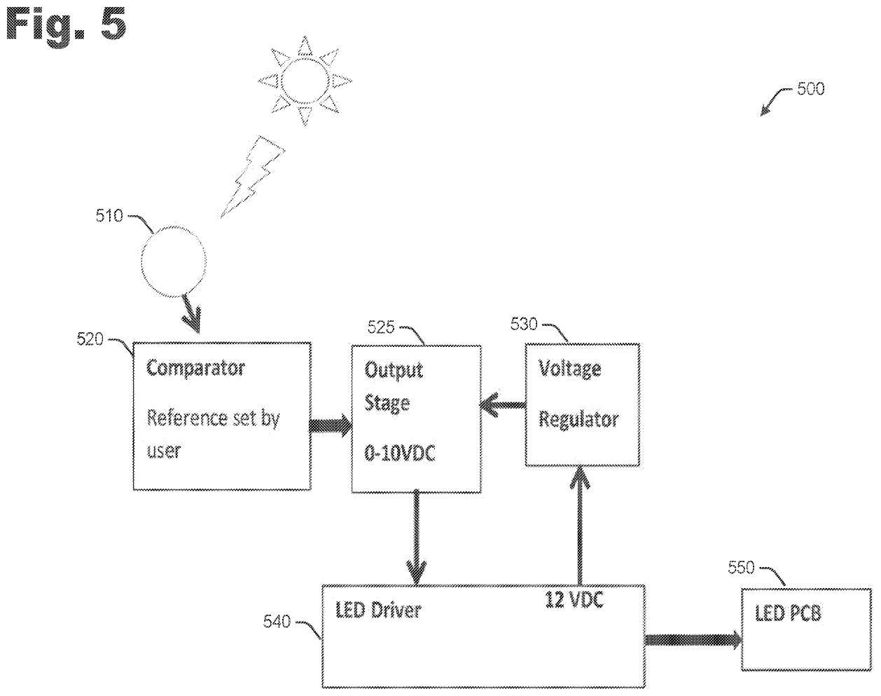

FIG. 5 is a block diagram illustrating operations 500 of an adaptive PAR sensor and controller. Actual light output is measured by a light sensitive device 510 when the light source (e.g., LED) is new or first put into service. That measurement is used as a reference set point by the luminaire electronics, the LED driver and the light sensitive device 510 for calibration. The light sensitive device, the third disclosed, may be a solar cell or linearized photodiode, phototransistor or other light sensitive device such as an LOR (light dependent resistor). The setpoint data is stored in a memory device that is part of the luminaire electronics.

In use, light sensitive device 510 is mounted on a luminaire such that it is in the direct or reflected path of the light and is constantly illuminated by the light, directly, or indirectly via a reflector or light pipe. Light sensitive device 510 may be mounted on a luminaire so as to be illuminated by one or more LED lights of the luminaire without being illuminated by ambient light entering the artificial grow environment from above. For example, FIG. 3 illustrates an implementation of luminaire wherein a sensor 310 is in a reflected path of light 320. The signal of light sensitive device 510 is monitored by comparator 520 to adjust the dimming voltage 525 up or down as needed via voltage regulator 530, output to the LED driver 540 and the LED circuit 550. The error signal is conditioned and then used to directly drive an LED controller's dimming input.

By way of illustration, if the luminaire is rated for continuous use at 100 Watts, the driver also is rated for 100 W. When the luminaire is new, the driver operates at a 30% dimming value of 70 W. Over time, the control system may up the current to compensate for lumen depreciation, to a maximum of 100 W in this example. At this point (or at any desired percentage) a warning signal may be issued. For example, a red light on the luminaire may be lit, or the luminaire may be operated to flash on and off. Other means may also be implemented, such as but not limited to a wireless or wired data signal transmitted to a central reporting station to alert the maintenance personnel to change the light.

A second technique to determine the LED status is to monitor the current use by the luminaire. A drop in current correlates to a drop in the LED light output. A series shunt in the LED Light DC line may be monitored for voltage fluctuations, including a voltage (IR) drop. This voltage may be fed to an analog to digital input of a microprocessor, which performs the necessary housekeeping. For example, the microprocessor may increase the LED current to compensate for LED depreciation. Or for example, the microprocessor may notify the user of end-of-life or an intermediate drop in light output level, via a wired or wireless signal.

Another technique is to combine the first and second techniques described above, to give a more sophisticated and robust light compensation and notification means.

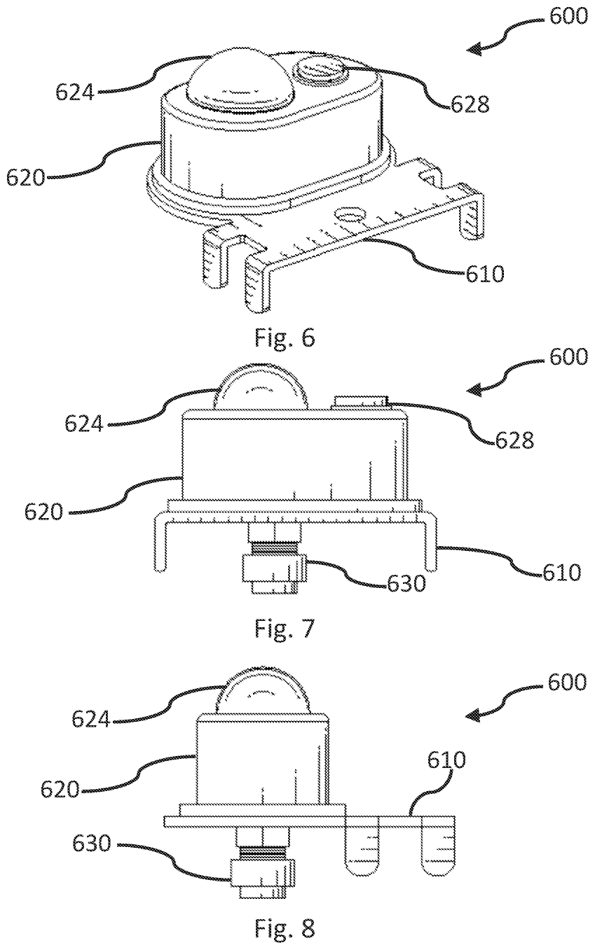

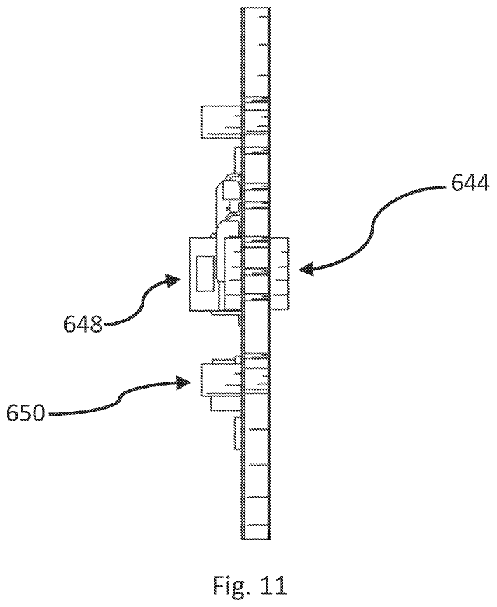

FIGS. 6-11 illustrate an example adaptive PAR sensor and controller 600. Adaptive PAR sensor and controller 600 includes a first light sensor and a hemispherical incident and translucent light housing 624 surrounding the first light sensor. A circuit (shown by way of example in FIG. 2) configured to supply 0 to 10 VDC to the dimming input of a constant current LED driver may be implemented in a PCBA contained within housing 620. A second light sensor is isolated from all light and may be provided to an opposide side of the PCBA from the hemispherical housing 624. By the circuit, an LED light may be linearly dimmed, from full-on to full-off, in inverse proportion to an amount of natural or ambient light received by the first light sensor as temperature-compensated in accordance with data collected by the second light sensor.

Mounting plate 610 facilitates gripping of a luminaire when installed therewith. Conduit coupling 630 enables coupling of a conduit to house wires configured to transmit power and control signals. Cover 628, selectively removable to permit entry to the interior of housing 620 enabling adjustment of a calibration potentiometer, may take the form of a thin metalized circular decal.

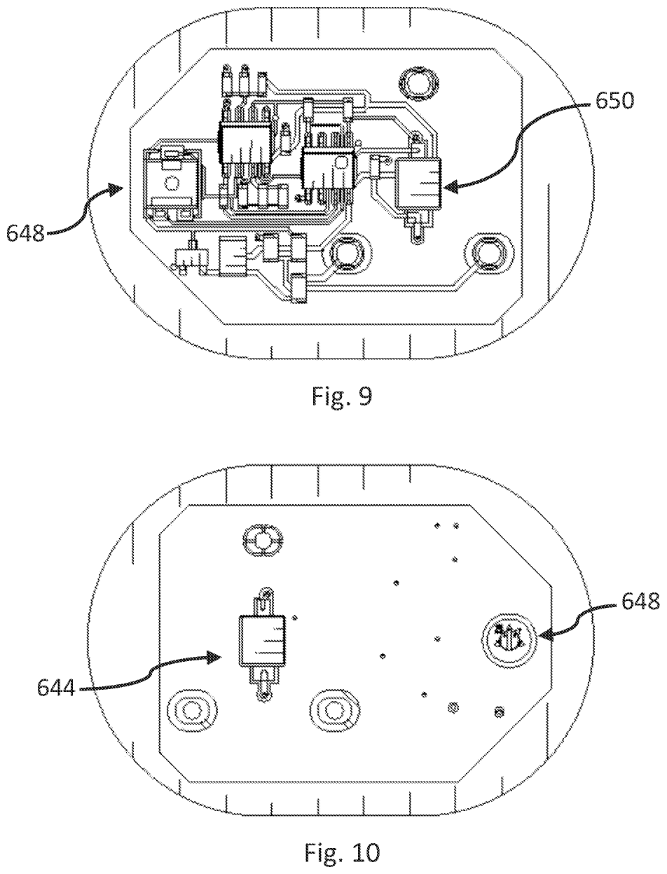

Considering the example PCBA of FIGS. 9-11, the adaptive PAR sensor and controller 600 includes a first light sensor 644 configured for placement behind/under for surrounding by hemispherical incident and translucent light housing 624. A second light sensor 654 is isolated from all light and is provided to an opposide side of the PCBA from the hemispherical housing first light sensor 644. Calibration potentiometer 648 is accessible through cover 628.

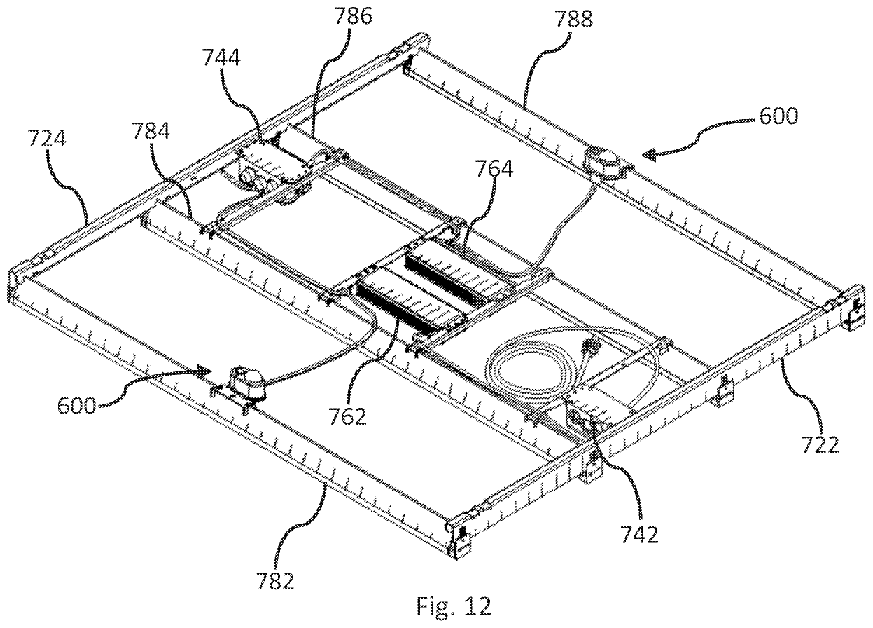

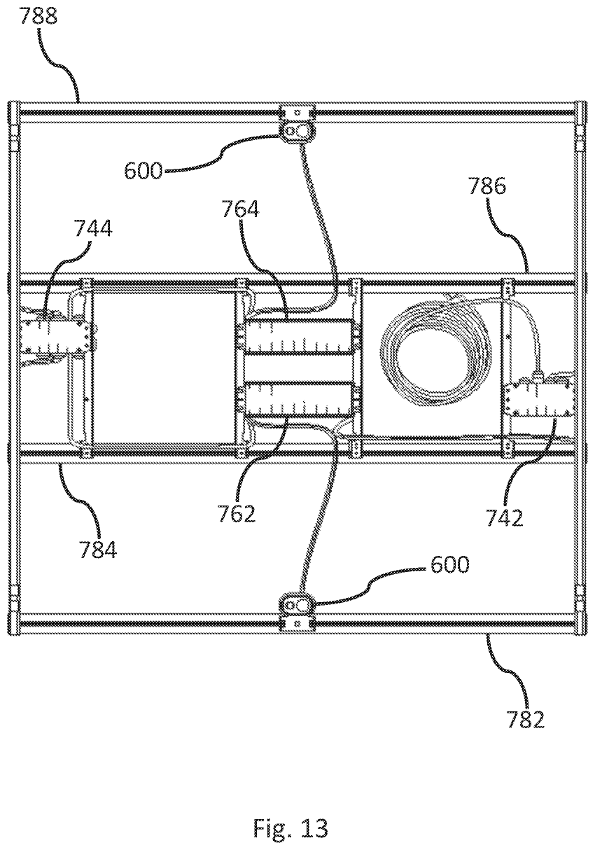

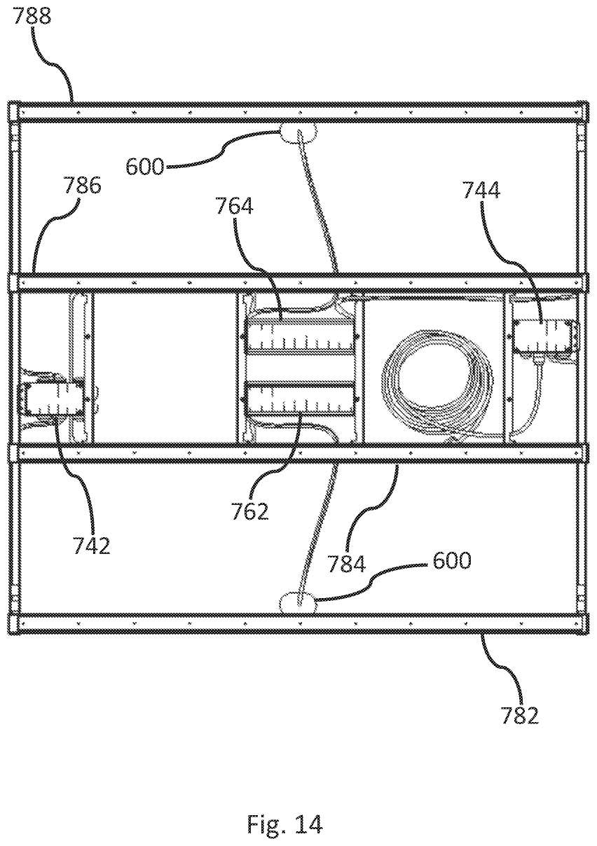

FIGS. 12-14 illustrate an example implementation of disclosed adaptive PAR sensor and controller systems in association with a luminaire fixture. The fixture includes luminaires 782, 784, 786 and 788 held together and partially supported by side rails 722 and 724. Constant current LED drivers 762 and 764 drive LEDs of the luminaires 782, 784, 786 and 788 which may be dimmed with a dimming input of LED drivers 762 and 764. Input junction box 742 and output junction box 744 support transmission of power, control or data signals to and from the artificial grow environment system.

Luminaires 782, 784, 786 and 788 are configured for illuminating an artificial grow environment below the luminaire. Each luminaire includes a light shield housing a PCB (such as 300, FIG. 3) including one or more LED lights (such as 320, FIG. 3). A constant current LED driver and with dimming input is operatively coupled with the PCB and/or LED light(s).

Within housing 620, the first light sensor, is coupled to a light shield of luminaire 782 through mounting plate 610 above or on top of the luminaire and separated from the LED light by the light shield so as to be isolated from the LED light. The first sensor receives ambient light in the artificial grow environment through hemispherical incident, translucent light housing 624 which is configured to accept light from above or from the sides in the artificial grow environment. More sunlight seen by adaptive PAR sensor and controller 600 will cause more dimming of the luminaires 782, 784, 786, 788. At a predetermined threshold the luminaires may shut off completely. Less sunlight seen by adaptive PAR sensor and controller 600 will cause less dimming.

It is noted that the examples shown and described are provided for purposes of illustration and are not intended to be limiting. Still other examples are also contemplated.

A method for monitoring and controlling an artificial grow environment includes providing a luminaire configured for illuminating an artificial grow environment and including a light shield housing at least one LED light and providing a constant current LED driver operatively coupled with the LED light and including a dimming input.

With a first light sensor coupled to the light shield and separated from the LED light thereby so as to be isolated from the LED light, natural or ambient light in the artificial grow environment is received through a hemispherical incident, translucent light housing configured to accept light from above and from the sides. The ambient light in the artificial grow environment received with the first light sensor further may be received with the first light sensor positioned above the luminaire.

With a circuit configured to supply 0 to 10 VDC to the dimming input of the constant current LED driver, the at least one LED light is linearly dimmed, from full-on to full-off in inverse proportion to an amount of ambient light received by the first light sensor as temperature-compensated in accordance with data collected by a second light sensor that is isolated from all light.

The at least one LED light may be linearly dimmed in inverse proportion to an amount of light received over a 24-hour duration or in inverse proportion to the DLI.

The method may further include measuring actual light output from the LED light with a third light sensor calibrated at an output reference set point of the constant current LED driver according to actual light output from the LED light when the light is first put into service. Actual light output from the LED light may be measured in a direct path or reflected path without illumination by ambient light entering the artificial grow environment from above.

The data collected by the third light sensor may be monitored with a comparator and dimming input may be adjusted in accordance with the monitored data from the comparator.

Current output may be increased over time with the constant current LED driver to compensate for lumen depreciation. At a preset value for current output a warning signal may be issued with the circuit.

The actions described above are only illustrative and other alternatives can also be provided where one or more actions are added, one or more actions are removed, or one or more actions are provided in a different sequence without departing from the scope of the claims herein.

Embodiments of the disclosure are susceptible to being used for various purposes, including, though not limited to, enabling users to govern the amount of supplemental lighting to make it as economical as possible to grow greenhouse crops.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim disclosed features are intended to be construed in a non-exclusive manner, namely allowing for items, components or elements not explicitly described also to be present. Reference to the singular is also to be construed to relate to the plural.

What is claimed is:

1. An artificial grow environment system, comprising:
a luminaire configured for illuminating an artificial grow environment below the luminaire, the luminaire including a light shield housing at least one LED light;
a constant current LED driver operatively coupled with the LED light and including a dimming input;
a first light sensor coupled to the light shield and separated from the LED light thereby so as to be isolated from the LED light and receive ambient light in the artificial grow environment;
a hemispherical incident, translucent light housing surrounding the first light sensor and configured to accept light from above or from the sides in the artificial grow environment;
a second light sensor isolated from all light; and
a circuit configured to supply 0 to 10 VDC to the dimming input of the constant current LED driver such that the LED light is linearly dimmed, from full-on to full-off, in inverse proportion to an amount of ambient light received by the first light sensor as temperature-compensated in accordance with data collected by the second light sensor.

2. The system as set forth in claim 1, wherein the first light sensor is positioned above the luminaire.

3. The system as set forth in claim 1, wherein the circuit configured to supply 0 to 10 VDC such that the LED light is linearly dimmed in inverse proportion to light received is configured to supply 0 to 10 VDC such that the LED light is linearly dimmed in inverse proportion to the amount of light received over a 24-hour duration.

4. The system of claim 1, further comprising a third light sensor configured to measure actual light output from the LED light.

5. The system of claim 4, wherein the third light sensor is calibrated at an output reference set point of the constant current LED driver according to actual light output from the LED light when the light is first put into service.

6. The system of claim 4, wherein the third light sensor is mounted on the luminaire so as to be illuminated by the LED light without being illuminated by ambient light entering the artificial grow environment from above.

7. The system as set forth in claim 4, wherein the third light sensor is mounted on the luminaire in a direct path of the LED light.
The system as set forth in claim 4, wherein the third light sensor is mounted in a reflected path of the LED light so as to be continuously illuminated by the light via a reflector or light pipe.

8. The system of claim 4, further comprising a comparator configured to monitor data collected by the third light sensor and wherein the circuit is configured to adjust dimming input in accordance with the monitored data from the comparator.
The system of claim 4, wherein the circuit is configured to directly drive the dimming input with a conditioned error signal based in part upon the output reference set point.

9. The system of claim 1, wherein the constant current LED driver is configured to increase current output over time to compensate for lumen depreciation.

10. The system of claim 9, wherein at a preset value for current output, the circuit is configured to issue a warning signal.

11. A method for monitoring and controlling an artificial grow environment, comprising:
providing a luminaire configured for illuminating an artificial grow environment and including a light shield housing at least one LED light;
providing a constant current LED driver operatively coupled with the LED light and including a dimming input;
with a first light sensor coupled to the light shield and separated from the LED light thereby so as to be isolated from the LED light, receiving ambient light in the artificial grow environment through a hemispherical incident, translucent light housing configured to accept light from above and from the sides; and
with a circuit configured to supply 0 to 10 VDC to the dimming input of the constant current LED driver, linearly dimming the LED light, from full-on to full-off in inverse proportion to an amount of ambient light received by the first light sensor as temperature-compensated in accordance with data collected by a second light sensor that is isolated from all light.

12. The method as set forth in claim 11, wherein receiving the ambient light in the artificial grow environment with the first light sensor further comprises receiving the ambient light with the first light sensor positioned above the luminaire.

13. The system as set forth in claim 11, wherein linearly dimming, from full-on to full-off in inverse proportion to the amount of ambient light received further comprises linearly dimming in inverse proportion to an amount of light received over a 24-hour duration.

14. The system of claim 11, further comprising measuring actual light output from the LED light with a third light sensor.

15. The system of claim 14, further comprising calibrating the third light sensor at an output reference set point of the constant current LED driver according to actual light output from the LED light when the light is first put into service.

16. The system of claim 14, further comprising measuring actual light output from the LED light with the third light sensor mounted on the luminaire so as to be illuminated by the LED light without being illuminated by ambient light entering the artificial grow environment from above.

17. The system as set forth in claim 14, further comprising measuring actual light output from the LED light with the third light sensor mounted on the luminaire in a direct path of the LED light.

18. The system of claim 14, further comprising monitoring data collected by the third light sensor with a comparator and adjusting dimming input in accordance with the monitored data from the comparator.

19. The system of claim 11, further comprising increasing current output over time with the constant current LED driver to compensate for lumen depreciation.

20. The system of claim 19, further comprising, with the circuit, issuing a warning signal with at a preset value for current output.
